(19) United States
(12) Patent Application Publication
(10) Pub. No.: US 2024/0289651 A1
(43) Pub. Date: Aug. 29, 2024

(54) INFORMATION PROCESSING APPARATUS, IMAGE CAPTURING APPARATUS, METHOD, AND NON-TRANSITORY COMPUTER-READABLE STORAGE MEDIUM

(71) Applicant: CANON KABUSHIKI KAISHA, Tokyo (JP)

(72) Inventor: Sohi KODAMA, Kanagawa (JP)

(21) Appl. No.: 18/443,414

(22) Filed: Feb. 16, 2024

(30) Foreign Application Priority Data
Feb. 27, 2023 (JP) 2023-028840

(51) Int. Cl. G06N 5/04; G06F 18/2415

(52) U.S. Cl. CPC G06N 5/04; G06F 18/2415

(57) ABSTRACT

There is provided with an information processing apparatus. A first determining unit determines a first task from among a plurality of tasks based on a result of inference in the plurality of tasks, in which each of a plurality of trained models executing different tasks performs inference for detecting a different detection target on evaluation data. A second determining unit determines a second task to be combined with the first task based on a result of inference in which an object that is not a detection target of the first task was erroneously detected for evaluation data corresponding to the first task by a trained model executing the first task among the plurality of trained models.

### BACKGROUND

### Field

The present disclosure relates to an information processing apparatus, an image capturing apparatus, a method, and a non-transitory computer-readable storage medium.

### Description of the Related Art

There is a technique in which a machine such as a computer learns and recognizes the contents of data such as images and sounds. The purpose of recognition processing by a computer is referred to as a “recognition task”, and a mathematical model for learning and executing a recognition task is referred to as a “recognition model”.

For example, recognition tasks include an object detection task for detecting specific objects (people, animals, vehicles, or the like) from images. In addition, there is a region detection task called semantic segmentation for detecting objects in units of pixels in an image. Besides such recognition tasks, there are various other recognition tasks such as an object category recognition task for determining the categories (human, animal, vehicle, etc.) of objects (subjects) in images, a tracking task for searching for and tracking a specific subject, and a scene type recognition task for determining scene types (city, mountain, seashore, etc.). In the following, recognition tasks will be referred to as “tasks”.

Neural networks (NNs) for learning and executing such tasks are known. Multilayer neural networks that are deep (that include many layers) are called deep neural networks (DNNs). DNN is short for “deep neural network”. In particular, convolutional neural networks that are deep are called deep convolutional neural networks (DCNNs). DCNN is short for “deep convolutional neural network”. DCNNs, with their high performance (recognition accuracy and recognition performance), have been attracting attention in recent years.

There is a technique called “multitask learning” in which a plurality of tasks are learned and executed using one recognition model. For example, Non-Patent Literature 1 (Caruana, R. (1997) “Multitask learning, Machine learning” 28(1), 41-75) discloses a method in which a plurality of tasks are learned using one DNN provided with a plurality of output units for the plurality of tasks. In Non-Patent Literature 1, the DNN includes, in a part thereof, a shared layer in which the same layer is used for all tasks, and the shared layer performs learning using training data for all tasks. There is disclosed a method in which network scale is reduced by determining whether or not a specific layer is to be shared as a shared layer among a plurality of multilayer neural networks (Japanese Patent No. 6750854).

### SUMMARY

According to the present disclosure, a combination of tasks that is suitable for performing multitask learning in a state in which a plurality of tasks are allocated to a plurality of networks can be determined.

The present disclosure can provide an information processing apparatus comprising at least one processor, and at least one memory coupled to the at least one processor, the memory storing instructions that, when executed by the processor, cause the processor to act as first determining unit configured to determine a first task from among a plurality of tasks based on a result of inference in the plurality of tasks, in which each of a plurality of trained models executing different tasks performs inference for detecting a different detection target on evaluation data, and second determining unit configured to determine a second task to be combined with the first task based on a result of inference in which an object that is not a detection target of the first task was erroneously detected for evaluation data corresponding to the first task by a trained model executing the first task among the plurality of trained models.

The present disclosure can provide a method comprising determining a first task from among a plurality of tasks based on a result of inference in the plurality of tasks, in which each of a plurality of trained models executing different tasks performs inference for detecting a different detection target on evaluation data, and determining a second task to be combined with the first task based on a result of inference in which an object that is not a detection target of the first task was erroneously detected for evaluation data corresponding to the first task by a trained model executing the first task among the plurality of trained models.

The present disclosure in its aspect provides a non-transitory computer-readable storage medium storing instructions that, when executed by a computer, cause the computer to perform a method comprising determining a first task from among a plurality of tasks based on a result of inference in the plurality of tasks, in which each of a plurality of trained models executing different tasks performs inference for detecting a different detection target on evaluation data, and determining a second task to be combined with the first task based on a result of inference in which an object that is not a detection target of the first task was erroneously detected for evaluation data corresponding to the first task by a trained model executing the first task among the plurality of trained models.

Further features of the present disclosure will become apparent from the following description of exemplary embodiments (with reference to the attached drawings).

### BRIEF DESCRIPTION OF THE DRAWINGS

FIG. 1 is a functional block diagram of an information processing apparatus according to a first embodiment.

FIG. 2 is a functional block diagram of an evaluation unit according to the first embodiment.

FIG. 3 is a functional block diagram of a combination determination unit according to the first embodiment.

FIG. 4 is a flowchart describing a flow of processing executed by the information processing apparatus according to the first embodiment.

FIG. 5 is a diagram illustrating a configuration of NNs according to the first embodiment in an initial state.

FIG. 6A is a diagram describing an erroneous detection image of a recognition model for a head detection task according to the first embodiment.

FIG. 6B is a diagram illustrating a teaching frame 601 of an erroneous detection image 600.

FIG. 7A is a diagram describing a result obtained by the recognition model for the head detection task according to the first embodiment performing inference on an image.

FIG. 7B is a diagram describing a result obtained by recognition models for tasks other than the head detection task according to the first embodiment performing inference on the image.

FIG. 8 is a diagram illustrating a recognition model that is suitable for a combination of the head detection task and a ball detection task according to the first embodiment.

FIG. 9 is a functional block diagram of an information processing apparatus according to a second embodiment.

FIG. 10 is a functional block diagram of a combination determination unit according to the second embodiment.

FIG. 11 is a flowchart describing a flow of processing executed by the information processing apparatus according to the second embodiment.

FIG. 12 is a functional block diagram of an information processing apparatus according to a third embodiment.

FIG. 13 is a functional block diagram of a combination determination unit according to the third embodiment.

FIG. 14 is a flowchart describing a flow of processing executed by the information processing apparatus according to the third embodiment.

FIG. 15A is a diagram describing an erroneous detection image of a recognition model for the head detection task according to the third embodiment.

FIG. 15B illustrates an erroneous detection image 1500 for the head detection task.

FIG. 16 is a diagram describing a result obtained by the recognition model for the head detection task according to the third embodiment performing inference on an evaluation image.

FIG. 17 is a diagram describing a configuration of a recognition model in a case in which the head detection task and an anti-erroneous detection task are combined according to the third embodiment.

FIG. 18 is a functional block diagram of a combination determination unit according to a fourth embodiment.

FIG. 19 is a flowchart describing a flow of processing executed by an information processing apparatus according to the fourth embodiment.

FIG. 20A is a diagram describing an image in which a head was not detected by a recognition model for the head detection task according to the fourth embodiment.

FIG. 20B is a diagram describing a teaching frame of an image 2000, and a teaching frame image.

FIG. 21 is a diagram illustrating a recognition model that is suitable for a combination of the head detection task and an anti-non-detection task according to the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

In the first embodiment, a task having the lowest inference accuracy is specified based on inference results of a plurality of NNs to which M types of tasks are allocated, and NNs other than an NN having executed the task having the lowest inference accuracy are caused to perform inference on an image (erroneous detection image) in which the NN having executed the task having the lowest inference accuracy erroneously detected a non-detection-target object, which is an object that is not a detection target. In the first embodiment, another task (second recognition task) to be combined with the task having the lowest inference accuracy (first recognition task) is determined based on degrees of matching between partial images obtained by the other NNs performing inference and an erroneous detection partial image (image including the non-detection-target object) of the NN having executed the task having the lowest inference accuracy. Thus, in the first embodiment, multitask learning can be performed in a state in which a combination including two tasks determined from among the plurality of tasks is allocated to one NN.

In the present embodiment, a combination of tasks that is most suitable for multitask learning of one NN is determined from among a plurality of tasks using an example in which object detection tasks for detecting heads, animals, balls, upper bodies, and vehicles are allocated to five NNs as the M types of tasks (M=5). However, the above-described combination of five object detection tasks is only one example, and does not limit the present disclosure. For example, a combination of object detection tasks may include object detection tasks for detecting faces, people, insects, trees, buildings, roads, etc. Furthermore, the number of object detection tasks is not limited to five, and may be four or less, or six or more.

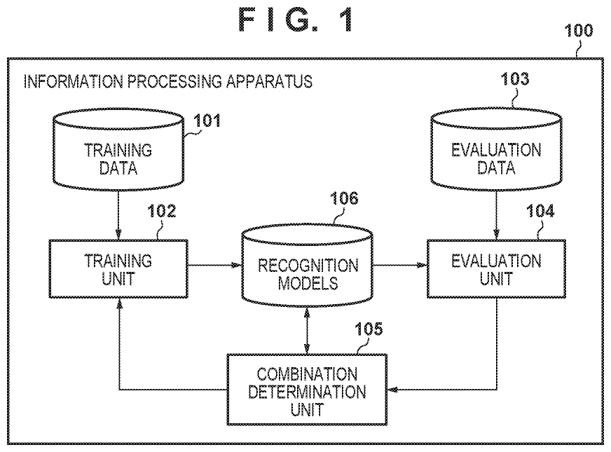

FIG. 1 is a functional block diagram of an information processing apparatus according to the first embodiment.

An information processing apparatus 100 includes a training unit 102, an evaluation unit 104, and a combination determination unit 105. Furthermore, for example, the information processing apparatus 100 may be installed in an image capturing apparatus (unillustrated) that includes an image capturing unit that captures an image of a subject, a smart speaker, or the like. Note that the functional units in the present description function as a result of at least one CPU (unillustrated) of the information processing apparatus 100 loading a program in a ROM (unillustrated) to a RAM and executing the program.

The training unit 102 trains each of a plurality of recognition models 106 using training data 101 (for example, images) and teaching data (ground truth data) that are associated with the recognition model 106. The plurality of recognition models 106 specifically refer to five recognition models. One task is allocated to each of the five recognition models 106. Note that, while only one recognition model 106 is illustrated in FIG. 1, the information processing apparatus 100 includes a plurality of recognition models 106. Here, the recognition models 106 are configured using multilayer NNs. The training methods of the recognition models 106 are the same as those for known multilayer NNs that are suitable for the respective object detection tasks, and description thereof is thus omitted.

The evaluation unit 104 calculates the inference accuracy of each of the plurality of recognition models 106 trained by the training unit 102 using evaluation data 103 (for example, images) and teaching data (ground truth data) that are associated with the recognition model 106. The evaluation unit 104 evaluates the inference performances of the plurality of recognition models 106 by comparing the inference accuracy of each of the plurality of recognition models 106 and a target inference accuracy. The evaluation unit 104 determines a first recognition task that corresponds to the lowest inference accuracy based on a result of the comparison between the inference accuracy of each of the plurality of recognition models 106 and the target inference accuracy. The evaluation unit 104 holds an evaluation result of the recognition model 106 for the first recognition task.

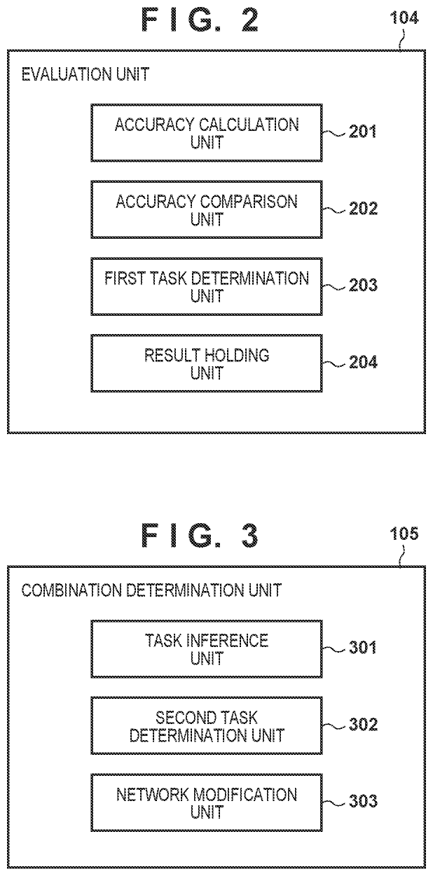

FIG. 2 is a functional block diagram of the evaluation unit according to the first embodiment. The evaluation unit 104 includes an accuracy calculation unit 201, an accuracy comparison unit 202, a first task determination unit 203, and a result holding unit 204.

The accuracy calculation unit 201 compares an inference result obtained by each of the plurality of recognition models 106 performing inference on evaluation data 103 (for example, images) corresponding thereto and ground truth data corresponding to the evaluation data 103. Thus, the accuracy calculation unit 201 calculates the inference accuracy of each of the recognition models 106. For example, the inference accuracy is a comparable evaluation criterion, such as a loss function value, accuracy, recall, or precision of regions detected from images with respect to ground truth data. In the following, the inference accuracy refers to the accuracy of regions detected from images.

The accuracy comparison unit 202 compares the inference accuracy of each of the plurality of recognition models 106 calculated by the accuracy calculation unit 201 and a preset target inference accuracy. For example, a result of the comparison may be a numerical difference or numerical ratio between the inference accuracy and the target inference accuracy. The result of the comparison in the present embodiment is a numerical difference between the inference accuracy and the target inference accuracy.

Based on a result of the comparison by the accuracy comparison unit 202, the first task determination unit 203 determines a task (first recognition task) not reaching the target inference accuracy. The number of tasks determined may be one, or a combination of two or more tasks.

The result holding unit 204 holds, as an inference result of the recognition model 106 to which the task determined by the first task determination unit 203 is allocated, an “erroneous detection image” and an “erroneous detection partial image” in the erroneous detection image. The erroneous detection image is an image in which the likelihood that the recognition model 106 has erroneously inferred a non-detection-target object, which is an object that is not a detection target, is higher than a threshold. The erroneous detection partial image is an image which has been cut out from the erroneous detection image and in which the non-detection-target object is surrounded by a detection frame. The likelihood is a numerical value (for example, probability) indicating the plausibility of objects being a detection target. Note that this likelihood is equal to the likelihood that the recognition model 106 has erroneously inferred a non-detection-target object, which is not a detection target. The threshold may be a numerical value set by a user as appropriate, or may be a numerical value in which the inference accuracy characteristic of the recognition model 106 is taken into consideration.

The combination determination unit 105 determines a second recognition task to be combined with the first recognition task determined by the evaluation unit 104 based on inference results of the recognition models 106 for tasks other than the task (first recognition task) determined by the first task determination unit 203. Furthermore, the combination determination unit 105 rewrites the network structure of a recognition model 106 based on the first and second recognition tasks.

FIG. 3 is a functional block diagram of the combination determination unit according to the first embodiment. The combination determination unit 105 includes a task inference unit 301, a second task determination unit 302, and a network modification unit 303.

The task inference unit 301 obtains inference results of the trained recognition models 106 for tasks other than the first recognition task by inputting the erroneous detection image in the result holding unit 204 to the trained recognition models 106 for the other tasks. The task inference unit 301 calculates regions in common between the erroneous detection partial image of the recognition model 106 for the first recognition task and partial images inferred from the erroneous detection image by the recognition models 106 for the other tasks. The regions in common are used as inference values.

The second task determination unit 302 determines the task associated with the highest inference value among the inference values calculated by the task inference unit 301 as the second recognition task. The network modification unit 303 rewrites the network structure of the recognition model 106 for the first recognition task into a network structure that is suitable for the combination of the first and second recognition tasks.

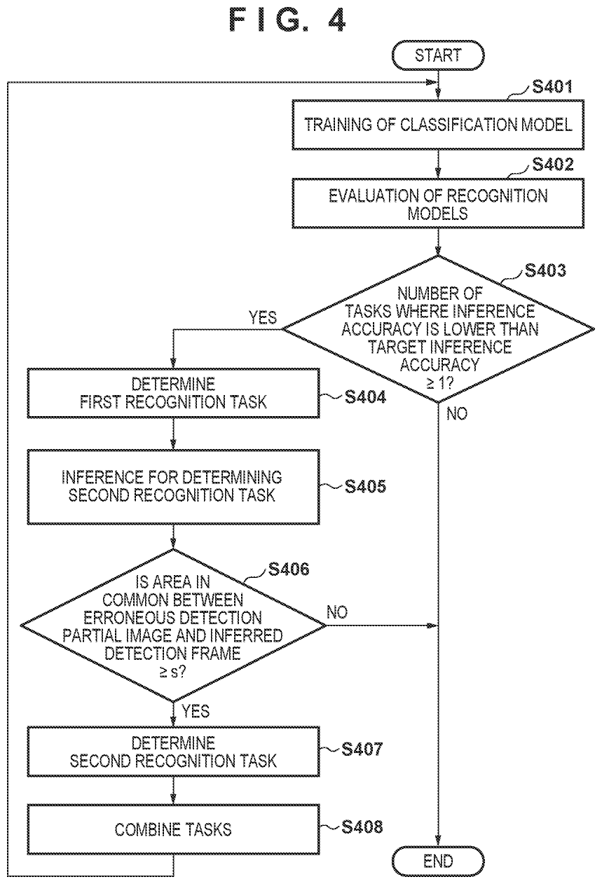

FIG. 4 is a flowchart describing a flow of processing executed by the information processing apparatus according to the first embodiment. This processing is realized as a result of at least one CPU (unillustrated) of the information processing apparatus 100 loading a program in a ROM (unillustrated) to a RAM and executing the program. Hereinafter, each process in the present description is realized by operations similar to this.

In step S401, the training unit 102 executes multitask training processing on the plurality of recognition models 106 using the training data 101 for the plurality of recognition models 106. A known method (see Non-Patent Literature 1) can be applied as the multitask training processing, and detailed description thereof is thus omitted.

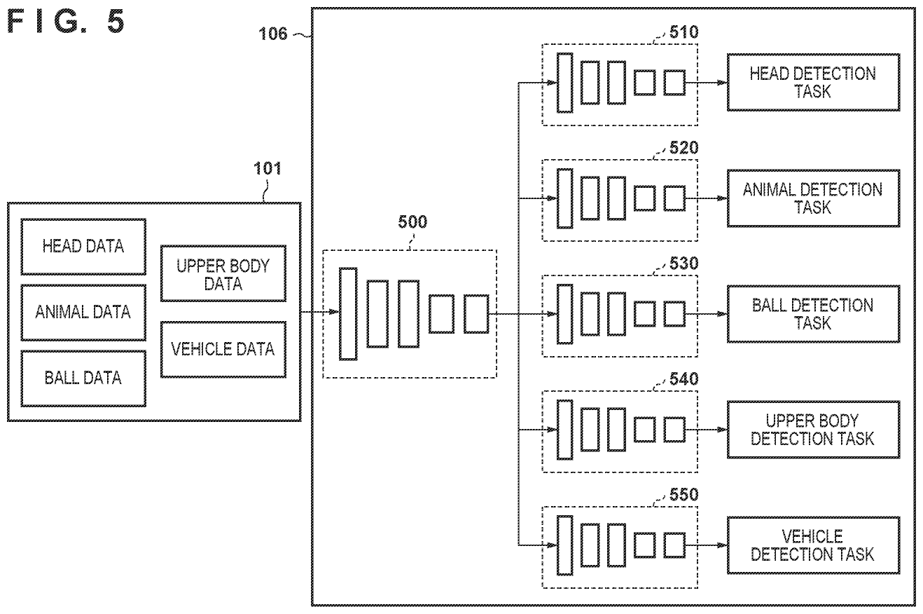

FIG. 5 is a diagram illustrating a configuration of the NNs according to the first embodiment in an initial state.

Training data 101 for each of the five tasks (object detection tasks for detecting heads, animals, balls, upper bodies, and vehicles) is inputted to the NNs as input data. The NNs include an upstream network 500 that serves as a shared layer in all tasks, and downstream networks 510 to 550 to which the five tasks are respectively allocated. For example, the head detection task is allocated to the downstream network 510. The animal detection task is allocated to the downstream network 520. The ball detection task is allocated to the downstream network 530. The upper body detection task is allocated to the downstream network 540. The vehicle detection task is allocated to the downstream network 550. For example, the NNs are DCNNs. DCNNs may have various configurations. Typically, by having a configuration in which convolutional layers and pooling layers are repeated, a DCNN can gradually compile local features in an input signal corresponding to a task and obtain information that is robust to deformation and displacement of a detection target. For example, the DCNNs may each be the NN disclosed in Non-Patent Literature 2 (A. Krizhevsky et al., “ImageNet Classification with Deep Convolutional Neural Networks”, Proc. Advances in Neural Information Processing Systems 25 (NIPS 2012)). Note that the recognition models 106 each have a configuration in which the upstream network 500 and one of the downstream networks 510 to 550 are connected. For example, the recognition model 106 for the head detection task has a configuration in which the upstream network 500 and the downstream network 510 are connected. Description is continued returning to FIG. 4.

In step S402, the accuracy calculation unit 201 evaluates inference accuracies based on inference results obtained by causing the plurality of recognition models 106 corresponding to the plurality of tasks to perform inference on evaluation data 103 (for example, images). The accuracy calculation unit 201 outputs the inference accuracy of each of the plurality of recognition models 106. An inference result includes a “likelihood” indicating a plausibility of objects detected in evaluation data 103 (image) being a detection target, and an “image” on which a detection frame of a detection target is overlaid and displayed. An inference accuracy is a numerical value quantitatively indicating the degree of match between inference results of each of the plurality of recognition models 106 and ground truth data of evaluation data 103. Here, the inference accuracies of the plurality of recognition models 106 are indicated by (head, animal, ball, upper body, vehicle)=(67%, 85%, 90%, 77%, 86%). For example, the accuracy calculation unit 201 evaluates that the inference accuracy of the recognition model 106 for the head detection task is 67%.

In step S403, the accuracy comparison unit 202 compares the target inference accuracies of the recognition models 106 and the inference accuracies of the recognition models 106 output by the accuracy calculation unit 201. Here, the target inference accuracies may be numerical values determined by the user in advance. The accuracy comparison unit 202 determines whether or not the total number of tasks whose recognition models 106 have inference accuracies lower than the target inference accuracies is one or more. Here, the target inference accuracies of the plurality of recognition models 106 are all 80%. The accuracy comparison unit 202 advances processing to step S404 upon determining that the total number of tasks whose recognition models 106 have inference accuracies lower than the target inference accuracies is one or more (Yes in step S403). The accuracy comparison unit 202 terminates processing upon determining that the total number of tasks whose recognition models 106 have inference accuracies lower than the target inference accuracies is not one or more (No in step S403).

In step S404, the first task determination unit 203 determines, as the first recognition task, a task for which the difference between the inference accuracy and the target inference accuracy is greatest among the tasks whose recognition models 106 have inference accuracies lower than the target inference accuracies. In the present embodiment, the head detection task is determined as the first recognition task. As an inference result of the recognition model 106 for the head detection task, the result holding unit 204 holds an erroneous detection image in which the likelihood that a non-detection-target object, which is an object that is not a detection target, has been erroneously detected is higher than a predetermined threshold. The result holding unit 204 may hold only one erroneous detection image, or may hold a plurality of erroneous detection images. In the present embodiment, the result holding unit 204 holds only one erroneous detection image. Furthermore, in addition to the erroneous detection image, the result holding unit 204 holds an erroneous detection partial image that is a part of the erroneous detection image.

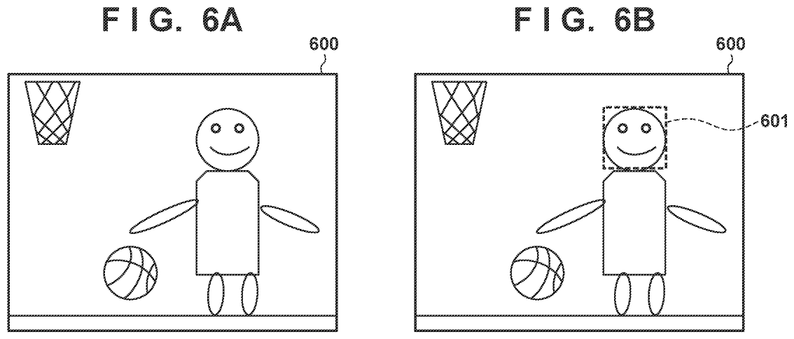

FIG. 6A is a diagram describing the erroneous detection image of the recognition model for the head detection task according to the first embodiment. FIG. 6A illustrates an erroneous detection image 600 which is included in evaluation data 103 (images) and in which the recognition model 106 for the head detection task has erroneously detected a non-detection-target object, which is an object that is not a detection target (head). FIG. 6B is a diagram illustrating a teaching frame 601 of the erroneous detection image 600. The teaching frame 601 indicates a detection target (i.e., ground truth) that the recognition model 106 for the head detection task should have detected from the erroneous detection image 600.

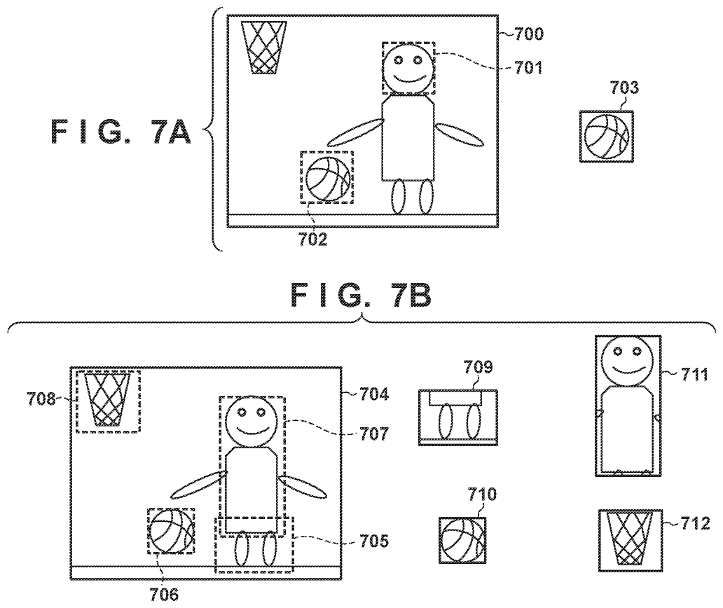

FIG. 7A is a diagram describing a result obtained by the recognition model for the head detection task according to the first embodiment performing inference on an image. FIG. 7B is a diagram describing a result obtained by the recognition models for tasks other than the head detection task performing inference on the image.

FIG. 7A is a diagram describing a result obtained as a result of the recognition model 106 for the head detection task performing inference on an image 700 (same as the erroneous detection image 600 in FIGS. 6A and 6B) included in evaluation data 103. An inference result of the recognition model 106 for the head detection task is indicated by a detection frame 701 and a detection frame 702. Upon detecting heads in the image 700, the recognition model 106 for the head detection task has erroneously detected a ball, which has a characteristic (sphere) similar to a head. The detection frame 701 is a correct detection because the detection frame 701 is detected at the same position as the teaching frame 601 in FIG. 6B. The detection frame 702 is an erroneous detection because the detection frame 702 is detected at a position that is different from that of the teaching frame 601. Accordingly, an image obtained by cutting out the image inside the detection frame 702 from the image 700 is used as an erroneous detection partial image 703. Description is continued returning to FIG. 4.

In step S405, in order to determine the second recognition task, the combination determination unit 105 causes the task inference unit 301 to execute inference on the erroneous detection image 600 using the recognition models 106 for the tasks other than the head detection task. The tasks other than the head detection task are the recognition tasks for recognizing animals, balls, upper bodies, and vehicles. Description is continued returning to FIG. 7B.

FIG. 7B is a diagram describing a result obtained by the recognition models 106 for the tasks other than the head detection task performing inference on the erroneous detection image 600. An image 704 indicates a result obtained by the recognition models 106 for the other tasks performing inference on the erroneous detection image 600. A detection frame 705 indicates an inference result of the recognition model 106 for the animal detection task. A detection frame 706 indicates an inference result of the recognition model 106 for the ball detection task. A detection frame 707 indicates an inference result of the recognition model 106 for the upper body detection task. A detection frame 708 indicates an inference result of the recognition model 106 for the vehicle detection task.

A partial image 709 is an image obtained by cutting out an area of the detection frame 705 from the image 704. A partial image 710 is an image obtained by cutting out an area of the detection frame 706 from the image 704. A partial image 711 is an image obtained by cutting out an area of the detection frame 707 from the image 704. A partial image 712 is an image obtained by cutting out an area of the detection frame 708 from the image 704. Description is continued returning to FIG. 4.

In step S406, the second task determination unit 302 calculates a ratio of an area in common between the erroneous detection partial image 703 erroneously detected by the recognition model 106 for the head detection task from the image 700 and each of the partial images 709 to 712 detected by the recognition models 106 for the tasks other than the head detection task from the image 704. The second task determination unit 302 determines whether or not the calculated ratios of the area in common are higher than a predetermined threshold s. The second task determination unit 302 advances processing to step S407 upon determining that a calculated ratio of the area in common is higher than the predetermined threshold s (Yes in step S406). The second task determination unit 302 terminates processing upon determining that the calculated ratios of the area in common are not higher than the predetermined threshold s (No in step S406).

In step S407, the second task determination unit 302 determines, as the second recognition task, a task other than the head detection task that is allocated to the recognition model 106 having inferred the partial image for which the ratio of the area in common with the erroneous detection partial image 703 is highest among the ratios of the area in common between the erroneous detection partial image 703 and the partial images 709 to 712. In the present embodiment, the second task determination unit 302 determines, as the second recognition task, the ball detection task, which is allocated to the recognition model 106 having inferred the partial image 710 (i.e., the detection frame 706) having a large area in common with the erroneous detection partial image 703.

In step S408, the network modification unit 303 performs processing for combining the first recognition task (head detection task) determined in step S404 and the second recognition task (ball detection task) determined in step S407. Specifically, the network modification unit 303 rewrites the network structure of the recognition model 106 for the head detection task into a network structure that is suitable for the combination of the head detection task and the ball detection task. Furthermore, the network modification unit 303 stores the modified network structure and learning parameters of the recognition model 106 for the head detection task in a storage device (unillustrated) of the information processing apparatus 100. For example, the storage device is a hard disk drive (HDD), a solid state drive (SSD), or an SD card.

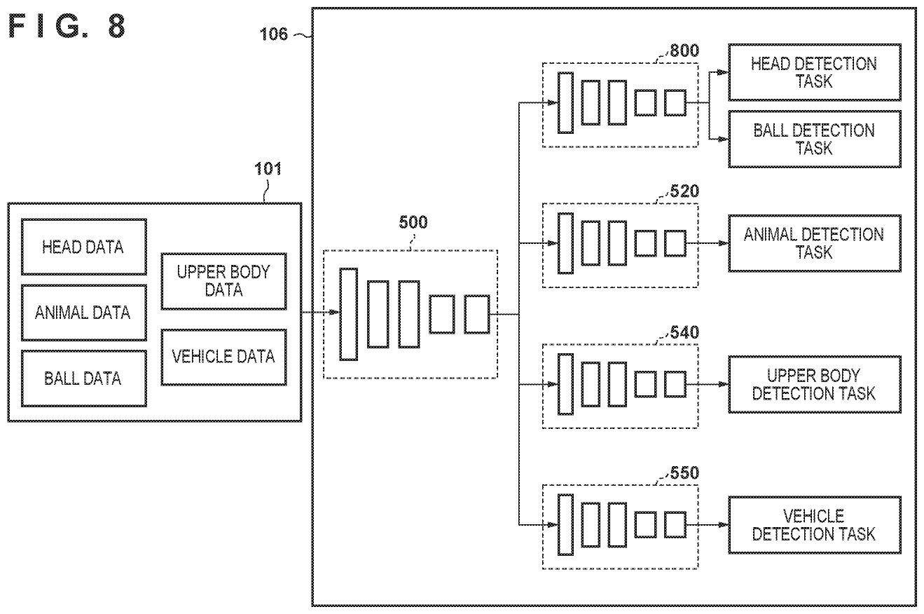

FIG. 8 is a diagram illustrating a recognition model that is suitable for the combination of the head detection task and the ball detection task according to the first embodiment.

A downstream network 800 has a network structure that is suitable for the combination of the head detection task and the ball detection task. The training data 101, the upstream network 500, and the downstream networks 520 to 550 are the same as those in the initial state in FIG. 5. Because the final layer of the downstream network 800 has a different weight coefficient for each task, only the final layer is an unshared layer. In FIG. 8, the unshared layer is illustrated in a simplified state. Description is continued returning to FIG. 4.

In step S408, the network modification unit 303 rewrites the network structure of the recognition model 106 for the head detection task as illustrated in FIG. 8, and returns processing to step S401. The training unit 102 executes re-training of the recognition model 106 for the head and ball detection task rewritten by the network modification unit 303.

By repetitively executing the processing in steps S401 to S408 as described above, combinations of tasks for reducing erroneous detection can be automatically determined from among the plurality of tasks. Thus, combinations of tasks that would result in the inference accuracies of recognition models for all tasks accomplishing the target inference accuracies can be efficiently determined.

### Second Embodiment

Differences from the first embodiment will be described in the second embodiment. In the first embodiment, in order to evaluate the inference accuracies of the other tasks, the recognition models 106 for the other tasks were caused to perform inference on the erroneous detection image erroneously detected by the recognition model 106 for the head detection task (first recognition task). In the first embodiment, a method was described in which a second recognition task that can be combined with the first recognition task is determined based on the ratios of the area in common between the erroneous detection partial image of the recognition model 106 for the first recognition task and partial images inferred by the recognition models 106 for the other tasks. In the second embodiment, a classification model that has learned in advance teaching images (images inside detection frames) of training data for all tasks is caused to perform inference on the erroneous detection partial image. In such a manner, in the second embodiment, a method will be described in which a second recognition task to be combined with the first recognition task is determined using a classification model.

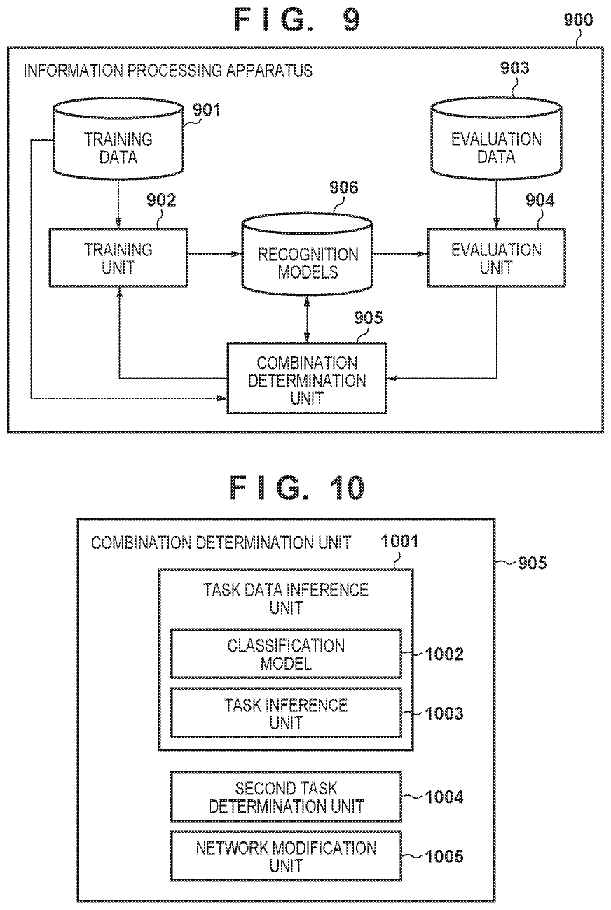

FIG. 9 is a functional block diagram of an information processing apparatus according to the second embodiment.

An information processing apparatus 900 has a configuration in which training data 901 and a combination determination unit 905 are connected. Note that the configuration of the combination determination unit 905 is partially modified from that in the first embodiment.

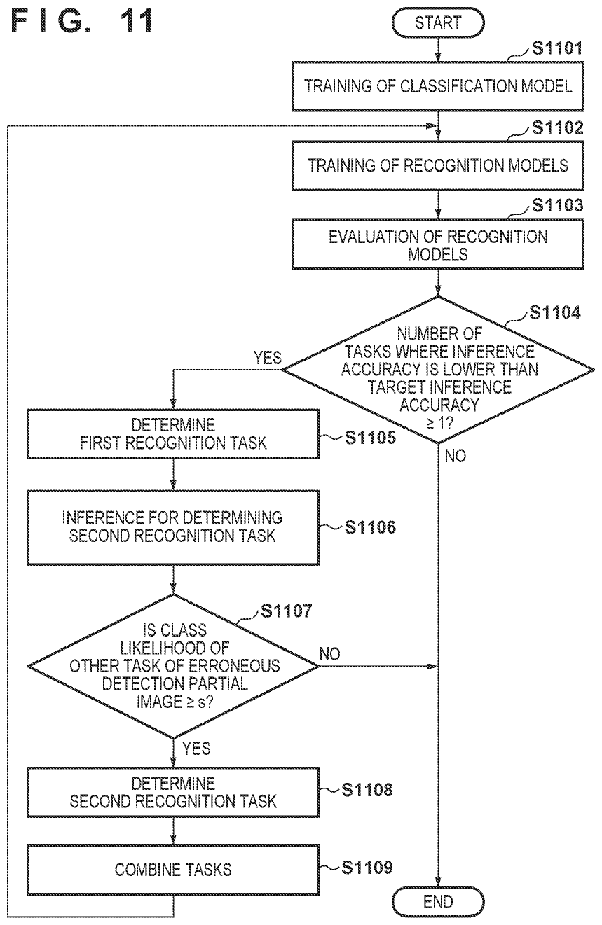

FIG. 10 is a functional block diagram of the combination determination unit according to the second embodiment. The combination determination unit 905 includes a task data inference unit 1001, a second task determination unit 1004, and a network modification unit 1005.

The task data inference unit 1001 causes a classification model 1002 to perform inference on an erroneous detection partial image of a recognition model 906 for the first recognition task determined by an evaluation unit 904. A task inference unit 1003 calculates likelihoods (hereinafter class likelihoods) of the erroneous detection partial image being classified as teaching images (images inside detection frames) of the other tasks. The class likelihoods are used as inference values.

FIG. 11 is a flowchart describing a flow of processing executed by the information processing apparatus according to the second embodiment.

In step S1101, a training unit 902 executes training of the classification model 1002 using teaching images (images inside detection frames) of training data for all tasks. The classification model 1002 learns images inside teaching frames for all tasks included in the training data 901, and learns task names associated with the images inside the teaching frames as ground truth labels. The training of the classification model 1002 may be executed by appropriate deep-learning-based machine learning in which a support vector machine, a multilayer neural network, etc., are used.

The processing in steps S1102 to S1105 is similar to the processing in steps S401 to S404 in FIG. 4, and description thereof is thus omitted. Note that the first recognition task in the present embodiment is the head detection task, as was the case in the first embodiment.

In step S1106, in order to determine the second recognition task, the combination determination unit 905 causes the task inference unit 1003 to execute inference of relevant tasks on the erroneous detection partial image 703 using the classification model 1002 trained in step S1101. The classification model 1002 executes inference as to which one of the teaching frame images of the head, animal, ball, upper body, and vehicle detection tasks the erroneous detection partial image 703 for the head detection task in FIG. 7A corresponds to, and calculates a class likelihood for each of the tasks. Here, the class likelihoods of the respective tasks calculated by the classification model 1002 are indicated by (head, animal, ball, upper body, vehicle)=(0.5, 0.3, 0.8, 0.4, 0.6).

In step S1107, the combination determination unit 905 determines whether or not at least one of the class likelihoods calculated in step S1106 is higher than a threshold s. Upon determining that at least one of the calculated class likelihoods is higher than the threshold s (Yes in step S1107), the combination determination unit 905 advances processing to step S1108. Upon determining that none of the calculated class likelihoods is not higher than the threshold s (No in step S1107), the combination determination unit 905 terminates processing. Here, the threshold s is 0.5. Thus, the ball detection task and the vehicle detection task become candidates of the second recognition task.

In step S1108, the second task determination unit 1004 determines the task having the highest class likelihood among the class likelihoods calculated in step S1106 as the second recognition task. The highest class likelihood among the class likelihoods calculated in step S1106 is 0.8; thus, the second task determination unit 1004 determines the ball detection task as the second recognition task.

The processing in step S1109 is similar to the processing in step S408 in FIG. 4, and description thereof is thus omitted.

In step S1109, the network modification unit 1005 rewrites the network structure of the recognition model 906 for the head detection task into a network structure that is suitable for the combination of the first and second recognition tasks. Then, processing returns to step S1102. The training unit 902 performs re-training of the recognition model 906 the network structure of which has been rewritten.

By repetitively executing the processing in steps S1101 to S1109 as described above, combinations of tasks for reducing erroneous detection can be automatically determined from among the plurality of tasks. Thus, combinations of tasks that would result in the inference accuracies of recognition models for all tasks accomplishing the target inference accuracies can be efficiently determined.

### Third Embodiment

In the third embodiment, a method will be described in which images including regions similar to the erroneous detection partial image of the first recognition task are collected from the training dataset for all tasks to newly create an anti-erroneous detection recognition task, and the created recognition task is determined as the second task.

FIG. 12 is a functional block diagram of an information processing apparatus according to the third embodiment.

An information processing apparatus 1200 has a configuration in which training data 1201 and a combination determination unit 1205 are connected to one another, and part of the configuration of the combination determination unit 1205 is modified. Other than the above-described configurations, the information processing apparatus 1200 has the same configuration as the information processing apparatus 100, and description thereof is thus omitted.

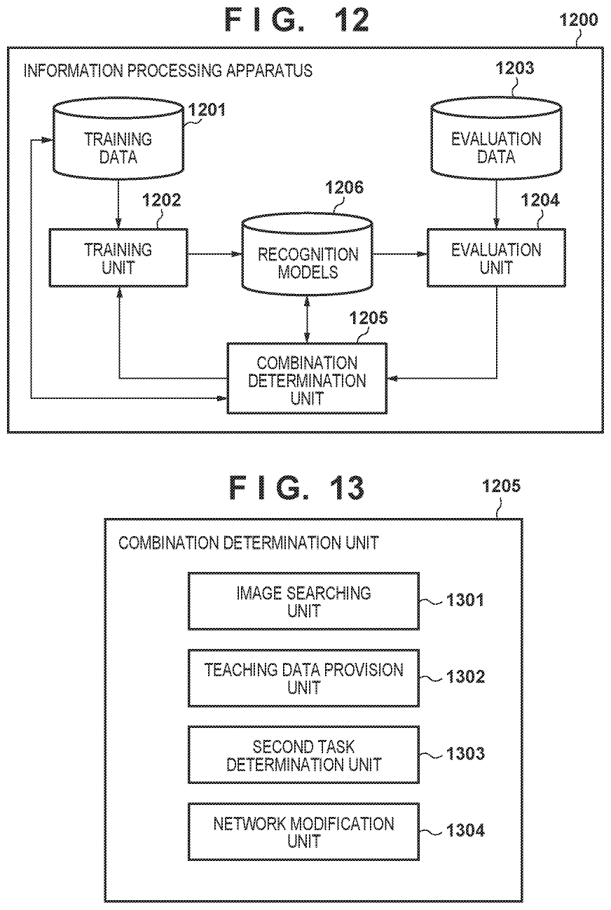

FIG. 13 is a functional block diagram of the combination determination unit according to the third embodiment. The combination determination unit 1205 includes an image searching unit 1301, a teaching data provision unit 1302, a second task determination unit 1303, and a network modification unit 1304.

The image searching unit 1301 performs a search in the training data 1201 for images including regions similar to the erroneous detection partial image of the first recognition task stored in an evaluation unit 1204, and outputs a result of the search for images to the teaching data provision unit 1302.

Based on the result of the search by the image searching unit 1301, the teaching data provision unit 1302 provides the regions similar to the erroneous detection partial image with teaching data consisting of coordinates and size, and creates a training dataset for a recognition model 1206 for a new task.

The second task determination unit 1303 creates, as the second recognition task, a new task that is associated with the training dataset created by the teaching data provision unit 1302. The network modification unit 1304 is the same as the network modification unit 303, and description thereof is thus omitted.

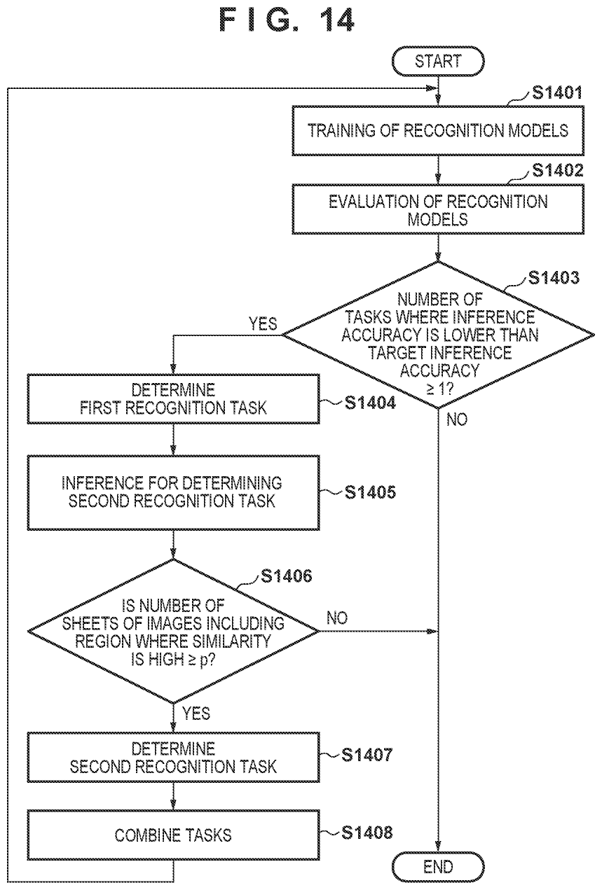

FIG. 14 is a flowchart describing a flow of processing executed by the information processing apparatus according to the third embodiment.

The processing in steps S1401 to S1404 is similar to the processing in steps S401 to S404 in FIG. 4, and description thereof is thus omitted. Note that the first recognition task in the present embodiment is the head detection task.

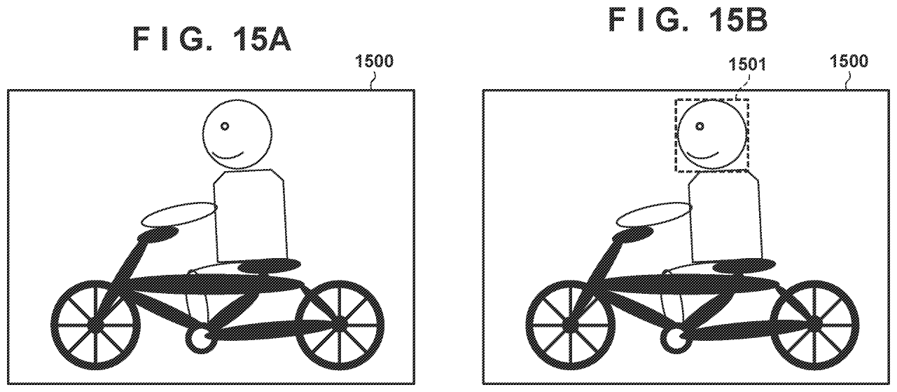

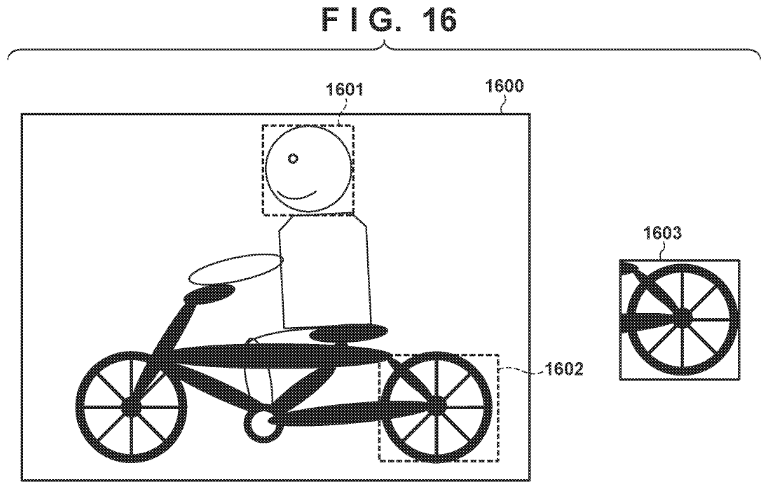

FIG. 15A is a diagram describing the erroneous detection image of the recognition model for the head detection task according to the third embodiment. FIG. 15A illustrates an erroneous detection image 1500 for the head detection task stored in the result holding unit 204 in step S1404. FIG. 15B illustrates a teaching frame 1501 in the erroneous detection image 1500. The teaching frame 1501 indicates a target (i.e., a head of a subject) that should be detected by the recognition model 1206 for the head detection task.

FIG. 16 is a diagram describing a result obtained by the recognition model for the head detection task according to the third embodiment performing inference on an evaluation image.

An image 1600 (same as the erroneous detection image 1500 in FIGS. 15A and 15B) indicates a result obtained as a result of the accuracy calculation unit 201 causing the recognition model 1206 for the head detection task to perform inference in step S1402. Detection frames 1601 and 1602 indicate a result obtained as a result of the recognition model 1206 for the head detection task performing inference on the image 1600. Upon detecting heads in the image 1600, the recognition model 1206 for the head detection task has erroneously detected a bicycle wheel, which has a characteristic (circular) similar to a head. The detection frame 1601 is a correct detection because the detection frame 1601 is located close to the region of the teaching frame 1501 in FIG. 15B. The detection frame 1602 is an erroneous detection because the detection frame 1602 is located at a position that is different from the region of the teaching frame 1501 in FIG. 15B. Accordingly, the image inside the detection frame 1602 is used as an erroneous detection partial image 1603.

In step S1405, the image searching unit 1301 performs a search in the training data 1201 for images for which a similarity between the erroneous detection partial image 1603 of the recognition model 1206 for the first recognition task and a region in the image is higher than a threshold s, and outputs the result of the search. The result of the search consists of images having high similarity with the erroneous detection partial image 1603, and the number of such images. Here, the number of images including regions having a similarity higher than the threshold s is 20,000. The search means is an appropriate search algorithm such as QBIC.

In step S1406, the image searching unit 1301 determines whether or not the number of images included in the result of the search is more than a threshold p. Upon determining that the number of images included in the result of the search is more than the threshold p (Yes in step S1406), the image searching unit 1301 advances processing to step S1407. Upon determining that the number of images included in the result of the search is less than the threshold p (No in step S1406), the image searching unit 1301 terminates processing. Here, the threshold p is 15,000 images.

In step S1407, the second task determination unit 1303 creates a new task (second recognition task) by providing teaching data to the images having high similarity with the erroneous detection partial image 1603. In this case, an anti-erroneous detection task that is different from the existing preset tasks is adopted as the second recognition task. In the following, the second recognition task may be referred to as an anti-erroneous detection task to facilitate understanding; these tasks, however, are the same task. The teaching data provision unit 1302 provides, as teaching data to each of the 20,000 images, the region in each of the images having high similarity with the erroneous detection partial image 1603 that has been output in step S1405. The teaching data that is provided includes the center coordinates and size of the region having high similarity. The teaching data provision unit 1302 adds the teaching data associated with each of the 20,000 images to the training data 1201 as training data for the second recognition task. The second task determination unit 1303 creates a second recognition task that is associated with the training dataset created by the teaching data provision unit 1302.

In step S1408, the combination determination unit 1205 combines the first recognition task (head detection task) and the second recognition task by adding the new task created in step S1407 to a recognition model 1206. The network modification unit 1304 rewrites the network structure of the recognition model 1206 for the head detection task into a network structure that is suitable for the combination of the head detection task and the second recognition task.

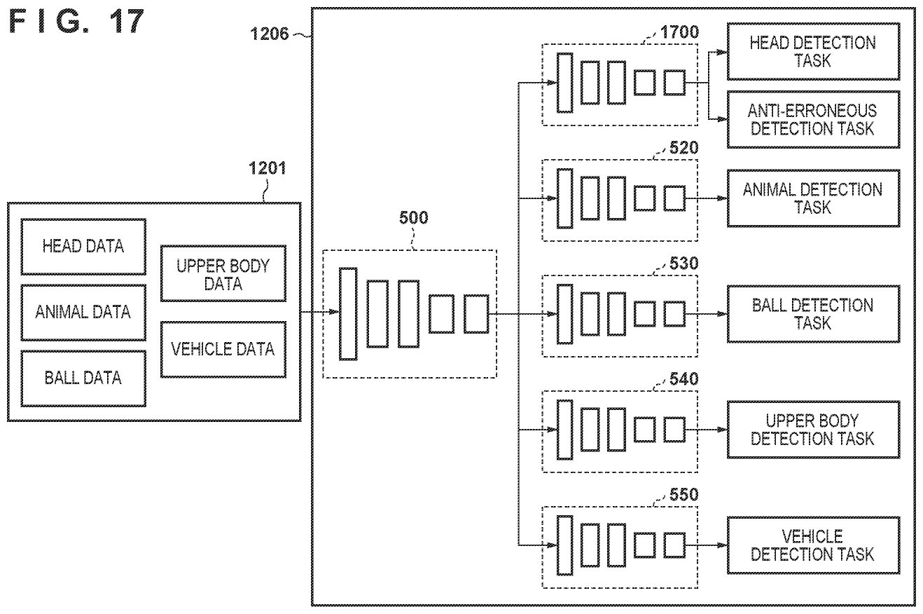

FIG. 17 is a diagram describing a configuration of a recognition model in a case in which the head detection task and the anti-erroneous detection task are combined according to the third embodiment.

A downstream network 1700 has a network structure obtained by combining the head detection task and the anti-erroneous detection task. The upstream network 500 and the downstream networks 520 to 550 are the same as those in the initial state in FIG. 5. Because a separate weight coefficient is provided for each task in the final layer of the downstream network 1700, only the final layer is an unshared layer. In FIG. 17, the unshared layer is illustrated in a simplified state. Description is continued returning to FIG. 14.

The network modification unit 1304 rewrites the network structure of the recognition model 1206 for the head detection task as illustrated in FIG. 17. Then, processing returns to step S1401. A training unit 1202 performs re-training of the plurality of recognition model 1206 the network structure of which has been rewritten.

By repetitively executing the processing in steps S1401 to S1408 as described above, a new task for reducing erroneous detection can be created from the plurality of tasks. Thus, a second recognition task (i.e., the new task) to be combined with the first recognition task can be automatically determined. Furthermore, combinations of tasks that would result in the inference accuracies of recognition models for all tasks accomplishing the target inference accuracies can be efficiently determined.

### Fourth Embodiment

In the fourth embodiment, the same classification model as that in the second embodiment is caused to perform inference on a teaching frame image in a non-detection image, which is an image in which the recognition model for the first recognition task could not detect a detection target upon performing inference on evaluation data. Furthermore, in the fourth embodiment, teaching frame images of detection targets having a size smaller than a predetermined size are extracted from a training dataset for a recognition task calculated by the classification model. Thus, in the fourth embodiment, a method will be described in which an anti-non-detection recognition task is newly created using the extracted teaching frame images to determine a second recognition task to be combined with the first recognition task. Note that the anti-non-detection recognition task is the second recognition task.

An information processing apparatus according to the fourth embodiment differs from the information processing apparatus 1200 in the third embodiment and has a configuration in which the role of the evaluation unit 1204 and the configuration of the combination determination unit 1205 are partially modified. Other than the above-described configurations, the information processing apparatus according to the fourth embodiment has the same configuration as the information processing apparatus 1200, and description thereof is thus omitted.

The evaluation unit 1204 will be described with reference to FIG. 2. The accuracy calculation unit 201, the accuracy comparison unit 202, and the first task determination unit 203 are the same as those in the first embodiment, and description thereof is thus omitted.

The result holding unit 204 holds a teaching frame image corresponding to an image (non-detection image) in which the recognition model 1206 for the first recognition task determined by the first task determination unit 203 could not detect a detection target upon performing inference on evaluation data. Note that “non-detection” refers to a state in which, when a recognition model 1206 has performed inference on evaluation data, there are no detection frames at regions of teaching frames that should be detected in the evaluation data.

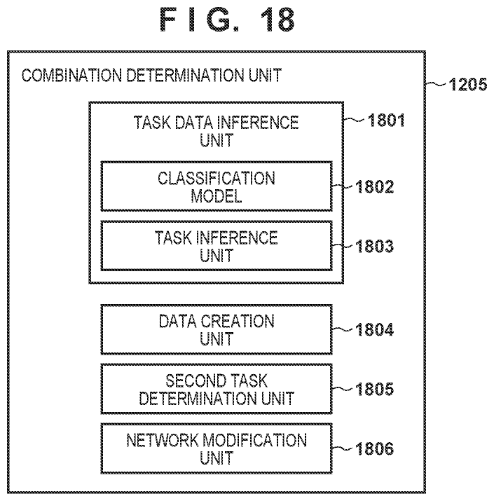

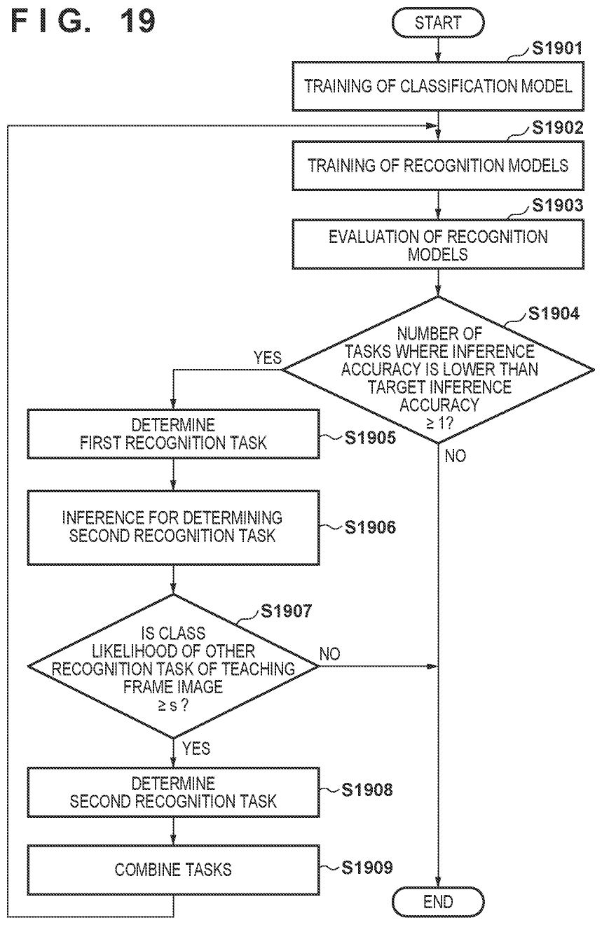

FIG. 18 is a functional block diagram of the combination determination unit according to the fourth embodiment. The combination determination unit 1205 includes a task data inference unit 1801, a data creation unit 1804, a second task determination unit 1805, and a network modification unit 1806.

The task data inference unit 1801 causes a task inference unit 1803 to perform inference, using a classification model 1802, on the teaching frame image (partial image in which detection target is encircled) for the first recognition task stored in the evaluation unit 1204. Note that the classification model 1802 is the same as the classification model 1002 in the second embodiment. The task inference unit 1803 calculates class likelihoods indicating which one of teaching frame images of the tasks other than the first recognition task the teaching frame image for the first recognition task is classified as. The class likelihoods calculated by the task inference unit 1803 are used as inference values.

The data creation unit 1804 selects a task other than the first recognition task that is associated with the highest inference value among the inference values calculated by the task inference unit 1803. The data creation unit 1804 extracts, from training data for the selected task, images provided with teaching frames having a size similar to that of the teaching frame image for the first recognition task, and outputs the result of the extraction. The data creation unit 1804 creates a training dataset from the output extraction result.

The second task determination unit 1805 creates a new task (second recognition task) that is associated with the training dataset created by the data creation unit 1804. The network modification unit 1806 is the same as the network modification unit 303, and description thereof is thus omitted.

FIG. 19 is a flowchart describing a flow of processing executed by the information processing apparatus according to the fourth embodiment. The processing in steps S1901 to S1904 is similar to the processing in step S1101 in FIG. 11 and steps S401 to S403 in FIG. 4, and description thereof is thus omitted.

In step S1905, the first task determination unit 203 selects, as the first recognition task, a task for which the difference between the inference accuracy and the target inference accuracy is greatest among the tasks whose recognition models 1206 have inference accuracies lower than the target inference accuracies. Here, the first recognition task is the head detection task. The result holding unit 204 holds therein a teaching frame image (image including head) of an image (non-detection image) in which the recognition model 1206 for the head detection task did not detect a head upon performing inference on evaluation data. The result holding unit 204 may hold a plurality of images, and the number of images held by the result holding unit 204 is not limited. In the present embodiment, the result holding unit 204 holds one image.

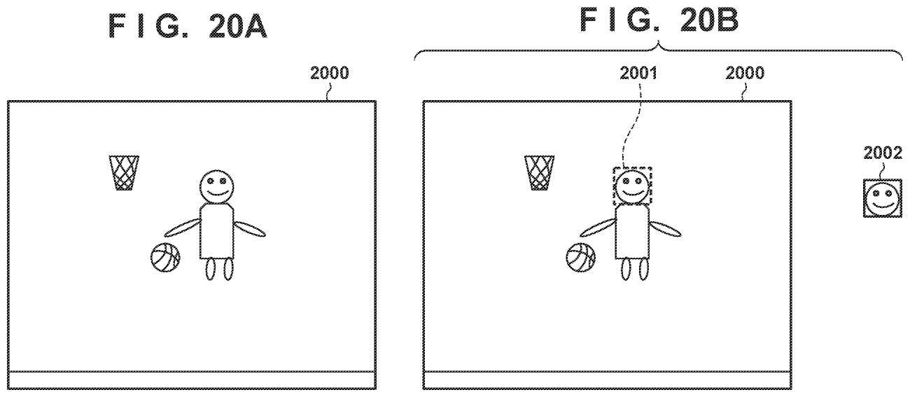

FIG. 20A is a diagram describing an image in which a head was not detected by the recognition model for the head detection task according to the fourth embodiment. FIG. 20A illustrates an image 2000 in which the recognition model 1206 for the head detection task could not detect a head. Because the head of the subject in the image 2000 is small, the recognition model 1206 for the head detection task cannot detect the head in the image 2000. FIG. 20B is a diagram describing a teaching frame of the image 2000, and a teaching frame image. A teaching frame 2001 indicates a teaching frame (frame encircling correct detection target) of the image 2000. The correct detection target here is the head of the subject. A teaching frame image 2002 is an image obtained by cutting out the area of the teaching frame 2001 from the image 2000. The teaching frame image 2002 includes only the head of the subject.

In step S1906, in order the determine the second recognition task, the combination determination unit 1205 causes the task inference unit 1803 to execute the following processing. The task inference unit 1803 calculates the class likelihood of the teaching frame image 2002 being classified into each task using the classification model 1802 having learned teaching frame images for all tasks in step S1901. The task inference unit 1803 calculates the class likelihood of the teaching frame image 2002 being classified as a teaching frame image of each of the head, animal, ball, upper body, and vehicle detection tasks using the classification model 1802. Here, the class likelihoods of the respective tasks are indicated by (head, animal, ball, upper body, vehicle)=(0.9, 0.3, 0.7, 0.4, 0.5). For example, the class likelihood of the teaching frame image 2002 being classified into the head detection task is 0.9. The higher the numerical value of class likelihood, the higher the possibility of the teaching frame image 2002 belonging to a given task.

In step S1907, the combination determination unit 1205 determines whether or not at least one of the class likelihoods of the tasks other than the first recognition task among the calculated class likelihoods is higher than a threshold s. Upon determining that at least one of the class likelihoods of the tasks other than the first recognition task is higher than the threshold s (Yes in step S1907), the combination determination unit 1205 advances processing to step S1908. Upon determining that at least one of the class likelihoods of the tasks other than the first recognition task is not higher than the threshold s (No in step S1907), the combination determination unit 1205 terminates processing. Here, the threshold s is 0.6.

In step S1908, the data creation unit 1804 creates a training dataset including data extracted based on a predetermined extraction condition from training data of a task other than the first recognition task that is selected based on a comparison of the class likelihoods calculated in step S1906. Furthermore, the data creation unit 1804 creates a new task (second recognition task) associated with the new training dataset. Note that, in the processing for comparing the class likelihoods calculated in step S1906, the data creation unit 1804 selects a task having the highest class likelihood among the tasks other than the first recognition task. The ball detection task, which is associated with the highest class likelihood (0.7) among the class likelihoods calculated in step S1906, is selected.

Furthermore, the data creation unit 1804 extracts images provided with teaching frames having a size similar to that of the teaching frame image 2002 from the training data for the ball detection task, and outputs the result of the extraction. The extraction condition may be the size of the teaching frame of the teaching frame image 2002, or the ratio of an entire image occupied by the size of a teaching frame. The result of the extraction includes images and teaching data associated with the images. Based on the result of the extraction, the data creation unit 1804 creates training data for a second recognition task, and adds the created training data to the training data 1201. The second task determination unit 1805 creates an anti-non-detection task (second recognition task) that is associated with the training dataset created by the data creation unit 1804. Here, the anti-non-detection task (second recognition task) refers to a task other than the recognition tasks prepared in advance.

In step S1909, the combination determination unit 1205 combines the first recognition task (head detection task) and the anti-non-detection task (second recognition task) created in step S1908. The network modification unit 1806 rewrites the network structure of the recognition model 1206 for the head detection task into a network structure that is suitable for the combination of the head detection task and the anti-non-detection task.

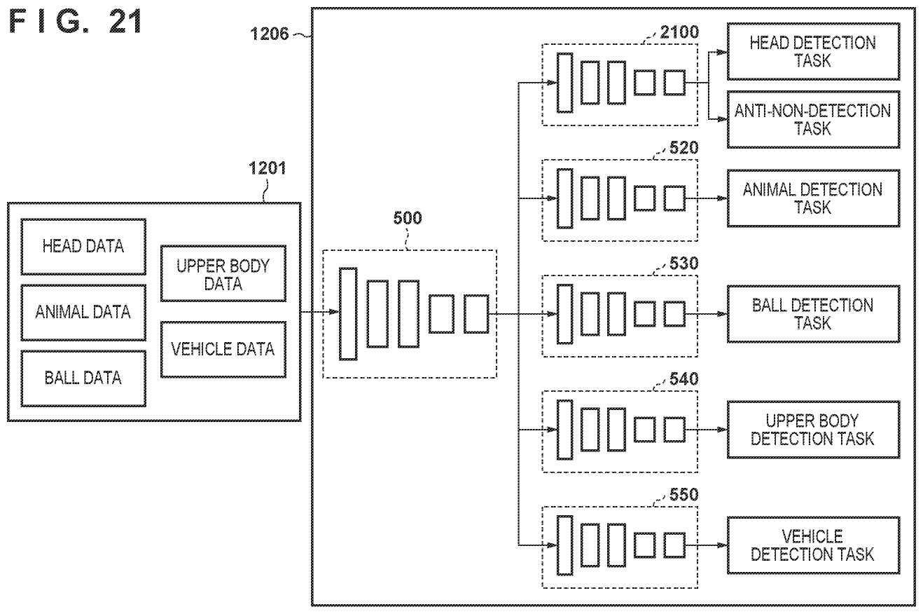

FIG. 21 is a diagram illustrating a recognition model that is suitable for a combination of the head detection task and the anti-non-detection task according to the fourth embodiment.

A downstream network 2100 has a network structure obtained by combining the head detection task and the anti-non-detection task. The upstream network 500 and the downstream networks 520 to 550 are the same as those in the initial state in FIG. 5. Because a separate weight coefficient is provided for each task in the final layer of the downstream network 2100, only the final layer is an unshared layer. In FIG. 21, the unshared layer portion is illustrated in a simplified state. Description is continued returning to FIG. 19.

Processing returns to step S1902 after the processing in step S1909 is completed. The training unit 1202 performs re-training of the recognition model 1206 the network structure of which has been rewritten.

By repetitively executing the processing in steps S1902 to S1909 as described above, a new task (second recognition task) can be created using a teaching frame image in a non-detection image in order to improve the inference accuracy of a recognition model for a task that cannot detect a detection target having a small size. In such a manner, an anti-non-detection task to be combined with the first recognition task can be automatically determined. Thus, combinations of tasks that would result in the inference accuracies of recognition models for all tasks accomplishing the target inference accuracies can be efficiently determined.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-028840, filed Feb. 27, 2023 which is hereby incorporated by reference herein in its entirety.

What is claimed is:

1. An information processing apparatus comprising:
at least one processor; and
at least one memory coupled to the at least one processor, the memory storing instructions that, when executed by the processor, cause the processor to act as:
first determining unit configured to determine a first task from among a plurality of tasks based on a result of inference in the plurality of tasks, in which each of a plurality of trained models executing different tasks performs inference for detecting a different detection target on evaluation data; and
second determining unit configured to determine a second task to be combined with the first task based on a result of inference in which an object that is not a detection target of the first task was erroneously detected for evaluation data corresponding to the first task by a trained model executing the first task among the plurality of trained models.

2. The information processing apparatus according to claim 1,
wherein the first determining unit determines the first task from among the different tasks based on an inference accuracy of each of the plurality of trained models as a result of inference being performed on the evaluation data.

3. The information processing apparatus according to claim 1,
wherein the second determining unit determines the second task from among the different tasks based on the inference result of the first task and a result obtained by trained models executing tasks other than the first task each performing inference on the evaluation data corresponding to the first task.

4. The information processing apparatus according to claim 1 further comprising
estimating unit configured to estimate one of the plurality of tasks to which the inference result of the first task belongs using a classification model that has learned ground truth data corresponding to the plurality of tasks,
wherein the second determining unit determines the second task from among the different tasks based on a result of the estimating by the estimating unit.

5. The information processing apparatus according to claim 1 further comprising
searching unit configured to perform a search in training data corresponding to the different tasks for an image of an object that is similar to the object included in the inference result of the first task,
wherein the second determining unit determines, as the second task, a task created based on a result of the searching by the searching unit and ground truth data corresponding to the result of the search.

6. The information processing apparatus according to claim 4 further comprising
extracting unit configured to extract, from training data corresponding to a task that is based on the result of the estimating by the estimating unit, an image including a second object of the task that has a predetermined size,
wherein the second determining unit determines, as the second task, a task created based on a result of the extracting by the extracting unit and ground truth data corresponding to the result of the extracting.

7. The information processing apparatus according to claim 1 further comprising:
controlling unit configured to perform control for modifying a network structure of the trained model executing the first task based on the first task and the second task, and adding second training data corresponding to the second task to first training data corresponding to the first task; and
storing unit configured to store a learning parameter and the network structure of the trained model executing the first task.

8. The information processing apparatus according to claim 1 further comprising:
training unit configured to train the plurality of trained models using a training dataset corresponding to the plurality of tasks; and
evaluating unit configured to evaluate inference accuracies of the plurality of trained models based on a result obtained by performing inference on the evaluation data and ground truth data corresponding to the evaluation data.

9. The information processing apparatus according to claim 5 further comprising
holding unit configured to hold: the evaluation data corresponding to the first task; a detection frame of at least one of the object erroneously inferred in the evaluation data corresponding to the first task by the trained model executing the first task and a correct detection object correctly inferred in the evaluation data corresponding to the first task by the trained model executing the first task; and a partial image of at least one of the object and the correct detection object.

10. The information processing apparatus according to claim 7 further comprising:
inputting unit configured to input evaluation data corresponding to the different tasks to the plurality of trained models based on a result of the storing by the storing unit; and
outputting unit configured to output a result obtained by the plurality of trained models performing inference on the evaluation data corresponding to the different tasks.

11. The information processing apparatus according to claim 1,
wherein the plurality of trained models each comprise a shared layer that executes same processing for the different tasks.

12. The information processing apparatus according to claim 1,
wherein the plurality of tasks include a head detection task, an animal detection task, a ball detection task, an upper body detection task, and a vehicle detection task.

13. An image capturing apparatus comprising:
an image capturing unit that captures an image of a subject; and
the information processing apparatus according to claim 1.

14. A method comprising:
determining a first task from among a plurality of tasks based on a result of inference in the plurality of tasks, in which each of a plurality of trained models executing different tasks performs inference for detecting a different detection target on evaluation data; and
determining a second task to be combined with the first task based on a result of inference in which an object that is not a detection target of the first task was erroneously detected for evaluation data corresponding to the first task by a trained model executing the first task among the plurality of trained models.

15. A non-transitory computer-readable storage medium storing instructions that, when executed by a computer, cause the computer to perform a method comprising:
determining a first task from among a plurality of tasks based on a result of inference in the plurality of tasks, in which each of a plurality of trained models executing different tasks performs inference for detecting a different detection target on evaluation data; and
determining a second task to be combined with the first task based on a result of inference in which an object that is not a detection target of the first task was erroneously detected for evaluation data corresponding to the first task by a trained model executing the first task among the plurality of trained models.
